(19) United States
(12) Patent Application Publication
(10) Pub. No.: US 2010/0293072 A1
(43) Pub. Date: Nov. 18, 2010

(54) Preserving the Integrity of Segments of Audio Streams

(76) Inventor: David Murrant, San Diego, CA (US)

Correspondence Address: CARR & FERRELL LLP, 2200 GENG ROAD, PALO ALTO, CA, 94303, US

(21) Appl. No.: 12/465,280

(22) Filed: May 13, 2009

(51) Int. Cl. G06Q 30/00; G06F 3/048; G06F 17/00; G06F 21/00; G06F 15/16; G06F 17/30

(52) U.S. Cl. 705/27; 715/716; 700/94; 726/30; 709/219

(57) ABSTRACT

Methods and systems for preserving the integrity of segments of audio streams are provided. An audio playback device may receive an audio stream from an audio transmission source. The audio stream may include a plurality of segments. The segments may each include a whole or partial song, talk program, commercial, DJ chatter, news or weather report, or the like. The audio stream may be temporarily stored in a buffer that contains a contiguous portion of the audio stream from a preceding time period. The buffer may reside in memory of the audio playback device. Indicia of a selection may be received via a user interface of the audio playback device. The indicia of the selection may be associated with the segment being currently received from the audio transmission source. The segment associated with the indicia of the selection may be stored in memory of the audio playback device.

### BACKGROUND OF THE INVENTION

1. Field of the Invention

The present invention generally relates to streaming audio technology. More specifically, the present invention relates to preserving segments of audio streams.

2. Description of the Related Art

Recording audio streams such as broadcasts of radio programs has taken place since the advent of portable cassette tapes. Recording steams of audio in this mainer, however, was (and to a lesser extent remains) indiscriminant as both desired and undesired segments of the audio stream are recorded. A desired segment may be a song or talk program, while an undesired segment may include disc jockey (DJ) chatter or a commercial that overlaps with an otherwise desired portion of the song or program.

While systems exist that screen out commercials and DJ chatter from a recorded audio stream, such systems are inaccurate. Use of such a system may result in excessive amounts of recorded material that still include undesired content. Alternatively, such a system may be overly selective and omit portions of desired content. Even a finely tuned system that precisely removes content from the beginning or end of an audio stream, such a system fails to address interruptions that might exist in the middle of the recorded stream.

Such systems also fail to offer any selectivity in the recording. The systems-regardless of their accuracy-record either all of an audio broadcast or none of the segments of a broadcast. As a result, a user will have to manually sort the recorded material for segments that are actually wanted. Even after a user has a set of desired audio segments (e.g., audio without DJ chatter), the user will ultimately be left with an incomplete audio stream. Removal of certain segments of chatter may ultimately require the removal of desired musical segments. As a result, a user will have to purchase the entirety of the musical track (e.g., a song) and then splice together the missing and acquired segments with the previously recorded and edited segments in an ad hoc. There is a need in the art for preserving the integrity of audio streams.

### SUMMARY

Embodiments of the present invention allow a segment of an audio stream to be preserved in response to a selection by a user.

In a first claimed embodiment, a method for preserving a segment of an audio stream is disclosed. An audio playback device may receive an audio stream from an audio transmission source. The audio stream may include a plurality of segments. The segments may each include a whole or partial song, talk program, commercial, DJ chatter, news or weather report, or the like. The audio stream may be temporarily stored in a buffer that contains a contiguous portion of the audio stream from a preceding time period. The buffer may reside in memory of the audio playback device. Indicia of a selection may be received via a user interface of the audio playback device. The indicia of the selection may be associated with the segment being currently received from the audio transmission source. The segment associated with the indicia of the selection may be stored in memory of the audio playback device.

In a second claimed embodiment, a system for preserving a segment of an audio stream is disclosed. The system includes a communications module stored in memory and executable by a processor to receive an audio stream from an audio transmission source. The audio stream may include a plurality of segments. The system also includes a buffering module stored in memory and executable by a processor to temporarily store the audio stream in a buffer that contains a contiguous portion of the audio stream from a preceding time period. The buffer may reside in memory of the audio playback device. Additionally, the system includes a selection module stored in memory and executable by a processor to receive via a user interface of the audio playback device indicia of a selection. The indicia of the selection may be associated with the segment being currently received from the audio transmission source. Furthermore, the system includes a data management module stored in memory and executable by a processor to store the segment associated with the indicia of the selection in memory of the audio playback device.

A third claimed embodiment discloses a computer readable storage medium having a program embodied thereon. The program is executable by a processor to perform method for preserving a segment of an audio stream. The method includes receiving at an audio playback device an audio stream from an audio transmission source, the audio stream comprising a plurality of segments; temporarily storing the audio stream in a buffer that contains a contiguous portion of the audio stream from a preceding time period, the buffer residing in memory of the audio playback device; receiving via a user interface of the audio playback device indicia of a selection, the indicia of the selection associated with the segment being currently received from the audio transmission source; and storing the segment associated with the indicia of the selection in memory of the audio playback device.

### BRIEF DESCRIPTION OF THE FIGURES

FIG. 1 is a block diagram illustrating an environment for preserving segments of audio streams received by an audio playback device from an audio transmission source.

FIG. 2 is a block diagram of the exemplary audio playback device of FIG. 1.

FIG. 3 is a block diagram of an exemplary segment preservation engine that may be included in the audio playback device.

FIG. 4 is a flowchart illustrating an exemplary method for preserving segments of an audio stream.

### DETAILED DESCRIPTION

Methods and systems for selectively preserving segments of audio streams are provided herewith. The audio streams may be provided by radio, satellite, or Internet broadcasts. While listening to an audio stream, a user may be able to select a segment currently being played. By temporarily storing a recent portion or portions of the audio stream in a buffer, the particular segment selected by the user may be stored in memory for later access. The stored segment may remain in memory until it is erased or overwritten or may be assigned to a playback button to allow the user to listen to the stored segment at any time. The stored segment may have limits as to its transferability to other media. The user may optionally purchase and download commercially available partial or whole copies of the stored segments or acquire the same from some other public source.

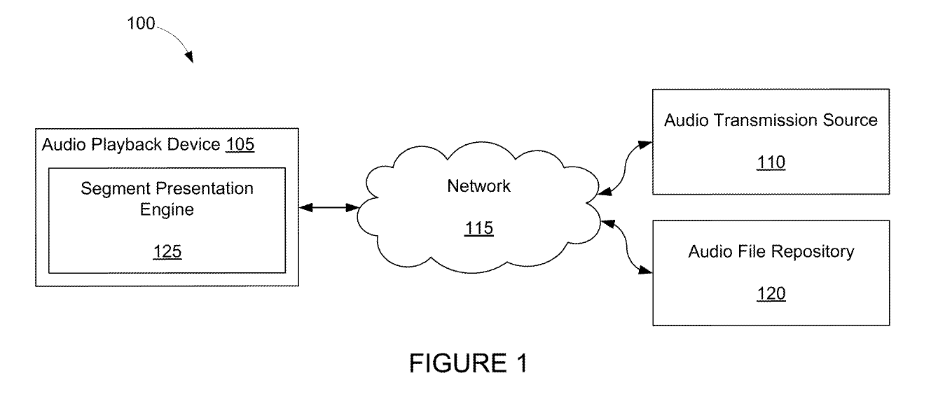

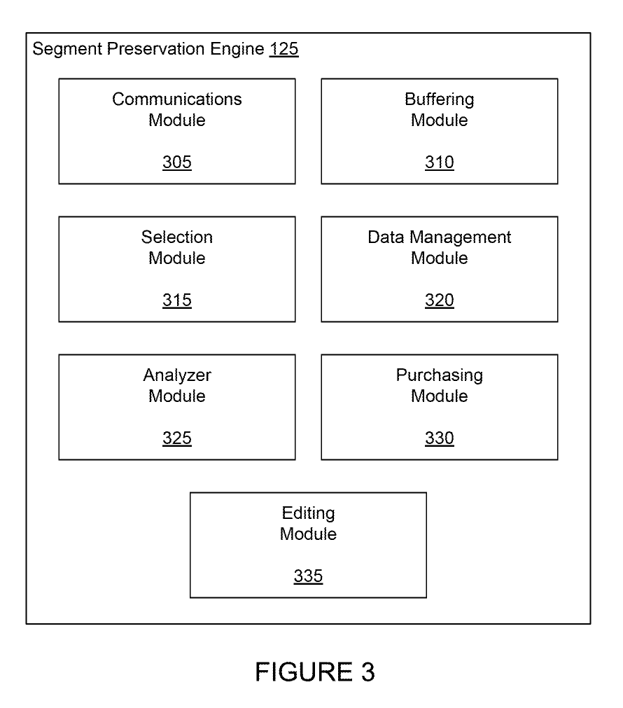

Referring now to FIG. 1, a block diagram is presented illustrating an environment 100 for preserving segments of audio streams received by an audio playback device 105 from an audio transmission source 110. The environment 100 of FIG. 1 includes the audio playback device 105 in communication with the audio transmission source 110 and an audio file repository 120 via a network 115. Alternatively, the audio file repository 120 may be excluded from the environment 100. Furthermore, the audio playback device 105 may include a segment preservation engine 125, which is discussed in further detail in the context of FIG. 3.

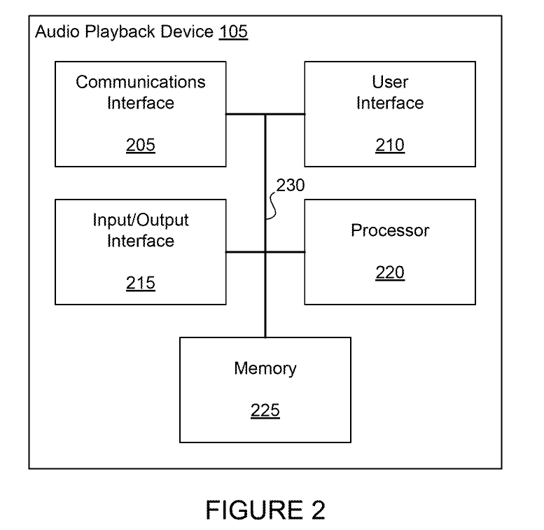

The audio playback device 105 may include any device capable of receiving and playing an audio stream. The audio stream may include any audio data transmission including digital or analog transmissions. The stream may be continuous in nature like that of radio transmissions, satellite transmissions, cellular transmissions, or web-based transmissions. Examples of the audio playback device 105 include those devices equipped with an AM/FM receiver, a satellite receiver, a cellular/general packet radio service (GPRS) receiver, or other input components for receiving audio streams. The audio playback device 105 may be embodied in a car stereo, a portable audio device, or various computing devices. Further details of the audio playback device 105 are discussed in the context of FIG. 2.

Audio streams may generally include contiguous segments of audio data. These segments may each include a whole or partial song, talk program, commercial, DJ chatter, or news or weather report. The audio stream may be degraded depending on various factors specific to, for example, the network 115 and audio transmission source 110 invoked in the environment 100. To illustrate, the audio stream may be degraded as a result of third-party voice-over, signal loss, signal compression, static noise, or signal interference. In some instances, the audio stream may be intentionally degraded.

The audio streams may also include information in addition to audio data utilized by the audio playback device 105. For example, the Radio Data System (RDS) is a communications protocol standard from the European Broadcasting Union for sending small amounts of digital information using conventional frequency modulation (FM) radio broadcasts. The RDS standardizes several types of information to be transmitted with audio data including time, track/artist info, program title, and station identification. The Radio Broadcast Data System (RBDS) is the U.S. version of the RDS. These two standards are nearly identical, with only slight differences, mainly related to numbers assigned to each of thirty one musical and other program formats the RDS and the RBDS can identify. Other information or metadata may also accompany audio information in an audio stream that may be used to accurately mark transitions between songs or programs and DJ or commercial interruptions.

The network 115 may include apparatus configured to facilitate communication between the audio playback device 105 and other elements of the environment 100. In some examples, the network 115 may include a radio broadcast system. Radio broadcast systems may be composed of one or more transmitting stations that broadcast an audio stream to the audio playback device 105. The audio stream may be broadcasted at some frequency such as those included in the amplitude modulation (AM) or FM bands. These transmitting stations may be linked by wire or microwave relay so that the same audio stream may be broadcasted by many stations.

The network 115 may also include any number of computers, computer terminals, and routers interconnected by telecommunication equipment or cables used to transmit or receive information. Furthermore, the network 115 may include elements of a satellite-based network or a cellular network. Moreover, a plurality of networks may be simultaneously included in the environment 100. For example, communication between the audio playback device 105 and the audio transmission source 110 may be facilitated by a radio broadcast system, while communication between the audio playback device 105 and the audio file repository 120 may be facilitated by a Wi-Fi or cellular network.

The audio transmission source 110 may include Internet radio broadcasts, satellite radio broadcasts, AM/FM radio broadcasts, or any other source for streaming or transmitting audio. Internet radio generally describes an audio broadcasting service transmitted via the Internet. Internet radio may sometimes be referred to as web radio, net radio, streaming radio, or e-radio. Satellite radio or subscription radio (SR) is generally understood as a digital radio service transmitted by a communications satellite. One service that provides satellite radio broadcasts is Sirius XM Radio, Inc. of New York City, N.Y. Traditional or ‘terrestrial’ radio broadcasts transmit audio information via the FM/AM radio broadcast systems generally described above although such systems have expanded to be inclusive of the likes of high definition radio, which is sometimes referred to as NRSC-5 or NRSC-5B.

In addition to broadcast, the audio transmission source 110 may transmit audio via multicast or unicast to the audio playback device 105. Multicasting describes simultaneously sending information from a single sender to a select group of receivers over a network such as the network 115. Unicast describes transmission between a single sender and a single receiver over a network such as the network 115. Multicast and unicast transmissions generally take place in the context of Internet radio.

The audio file repository 120 may include stored collections of audio files or segments of audio files that may be accessed by the audio playback device 105 or an ancillary device via network 115. The audio file repository 120 may be a vendor of the audio files. For example, the audio file repository 120 may include the iTunes Store operated by Apple, Inc. of Cupertino, Calif., or AmazonMP3 operated by Amazon.com, Inc. of Seattle, Wash. Both the iTunes Store and AmazonMP3 are accessible via the Internet. The audio transmission source 110 and the audio file repository 120 may be one and the same.

FIG. 2 is a block diagram of an exemplary audio playback device like the audio playback device 105 of FIG. 1. The audio playback device 105 of FIG. 2 includes a communications interface 205, a user interface 210, an input/output interface 215, a processor 220, and memory 225. Any hardware platform suitable for performing the processing described herein may be suitable for use with embodiments of the presently disclosed invention. A bus 230 may provide communication between the communications interface 205, the user interface 210, the input/output interface 215, the processor 220, and memory 225.

The communications interface 205 may be configured to provide communication between the audio playback device 105 and both the audio transmission source 110 and the audio file repository 120. As such, the communications interface 205 may include one or more antennae capable of receiving wireless signals from radio broadcast stations, communications satellites, cellular transmitters, and/or Wi-Fi from Internet broadcasters. Such antennae may also allow signals to be sent from the audio playback device 105 to the audio transmission source 110 or the audio file repository 120.

The user interface 210 allows a user to interact with the audio playback device 105. The user interface 210 may include, for example, one or more of a touch screen, a display, a button, or a switch. The user may make selections related to the audio transmission source 110, the audio file repository 120, and an audio stream received from the audio transmission source 110 through the user interface 210.

The input/output interface 215 of FIG. 2 provides communication between the audio playback device 105 and other digital devices. The input/output interface 215 may provide wired or wireless communication with these other digital devices. In one example, the input/output interface 215 includes a USB interface.

The processor 220 includes a device (or series of devices) that execute instructions to effectuate the functionality described by those instructions. Such instructions may be stored in memory 225. The processor 220 may include a microprocessor or a central processing unit. Processor 220 may also be an application specific integrated circuit or a ‘system on a chip’ microcontroller.

The memory 225 may include computer-readable storage media for providing instructions to the processor 220 for execution. Such media can take many forms, including but not limited to, non-volatile and volatile media such as optical or magnetic disks and dynamic memory, respectively. Common forms of computer-readable storage media include a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

The bus 230 may include various forms of transmission media to carry one or more sequences of one or more instructions to the processor 220 for execution. The bus 230 may carry data to the memory 225, from which the processor 220 retrieves and executes the instructions. The instructions received by the memory 225 can optionally be stored on a fixed disk either before or after execution by the processor 220.

FIG. 3 is a block diagram of the exemplary segment preservation engine 125. The segment preservation engine 125, as depicted, includes a communications module 305, a buffering module 310, a selection module 315, a data management module 320, an analyzer module 325, a purchasing module 330, and an editing module 335. The segment preservation engine 125 and its constituent modules may be stored in the memory 225 and executed by the processor 220 to effectuate the functionality corresponding thereto. The segment preservation engine 125 may be composed of more or less modules (or combinations of the same) and still fall within the scope of the present invention. For example, the functionality of the analyzer module 325 and the functionality of the editing module 335 may be combined into a single module.

Through execution of the communications module 305 of FIG. 3, the audio playback device 105 receives an audio stream from the audio transmission source 110, which may include a plurality of segments. The segments may each include all or part of a song, talk program, commercial, DJ chatter, news or weather report. Information beyond audio data may also be received with the audio stream such as RDS and RBDS related information, or various metadata. This information may be used by various modules of the segment preservation engine 125 to accurately mark transitions between segments.

This information may also be used to tag the segments with pertinent data such as with an ID3 tag. ID3 describes a metadata container often used in conjunction with the MP3 audio file format that allows information such as title, artist, album, track number, or other information about the file to be stored in the file itself.

Execution of the communications module 305 may further provide communication with the audio file repository 120. Such communication may be unidirectional or bidirectional. For example, the communications module 305 may be executable by a processor to send a request for, and download, a clean copy of a given segment to the audio playback device 105. The clean copy of the given segments may be an audio file of the same material as the given segment without, or with less, degradation. To illustrate, the given segment may be a particular song broadcasted by a radio station that is degraded by static. The clean copy of that song or segments thereof may be an MP3 file of a studio recording of that song or segment with little to no degradation.

Execution of the communications module 305 may also provide unidirectional or bidirectional communication with other digital devices (not depicted) as might occur through the input/output interface 215. These devices may include portable media playback devices. These devices may also include peripheral storage devices such as an external hard drive or a thumb drive. Any of these devices may be communicatively coupled, either wirelessly or wired, to the audio playback device 105 via the input/output interface 215. The audio playback device 105 may read or download audio files from these other digital devices.

Execution of the buffering module 310 of FIG. 3 allows the audio stream to be temporarily stored in a buffer. The buffer may contain a contiguous portion of the audio stream from a preceding time period. For example, the buffer may contain the last ten minutes of the audio stream received by from the audio transmission source 110. The buffer may reside in the memory 225 of the audio playback device 105. The buffer may occasionally be flushed such as when power to the audio playback device 105 is lost or there is a change in audio transmission source 110 (e.g., changing stations).

Execution of the selection module 315 of FIG. 3 provides for indicia of a selection to be received via the user interface 210 of the audio playback device 105. The indicia of the selection may be associated with the segment currently being received from the audio transmission source 110. For example, a user may be listening to a segment of the audio stream being played on the audio playback device 105 and make a selection indicative of that segment. The selection by the user may be made in various ways such as by pressing and holding a button on the user interface 210, much like radio station presets are often selected.

The data management module 320 of FIG. 3 is executable to provide management of data stored in the memory 225 of the audio playback device 105. For example, execution of the data management module 320 may allow the segments associated with the indicia of the selection to be stored in the memory 225 of the audio playback device 105. The stored segments may remain in the memory 225 until erased or overwritten. Additionally, a total number of stored segments may be limited. Storage of the segments may be aided by execution of the analyzer module 325 as described further. Execution of the data management module 320 may also allow information to be associated with the stored segments. This information may include an artist name or a song title, or other information beyond audio data received by execution of the communications module 305.

The data management module 320 may be further executed to manage a playlist stored in the memory 225 of the audio playback device 105. Such a playlist may include the stored segments from the received audio stream and/or audio files received from the audio file repository 120 or other digital playback and storage devices communicatively coupled to the audio playback device 105. The user may access and manipulate the playlist using the user interface 210 of the audio playback device 105.

Execution of the analyzer module 325 allows the buffer to be analyzed to determine the beginning and the end of the segment associated with the indicia of the selection by the user. Determination of the beginning and the end of a segment in the buffer may allow that segment to be accurately identified and stored in the memory 225 of the audio playback device 105 without extraneous audio information such as DJ chatter and commercials.

Through execution of the purchasing module 330, a user may purchase at least a portion of a clean copy of the segment associated with the indicia of the selection. The purchasing module 330 may use information associated with a given segment such as an artist name or track title to identify that segment for purchase. The purchased clean copy may be downloaded from the audio file repository 120 by execution of the communications module 105 and stored in the memory 225. The user may have an account with the audio file repository 330 or other entity to handle any monetary exchange.

Execution of the editing module 335 of FIG. 3 allows the stored segments to be edited in various manners. For example, at least a portion of a given stored segment may be replaced with a corresponding portion of a clean copy. This may be performed when a portion of the stored segment is damaged or obscured by DJ chatter or the like. The editing module 335 may also intentionally degrade the stored segment. Furthermore, the editing module 335 may apply a digital rights management wrapper to the stored selected segment.

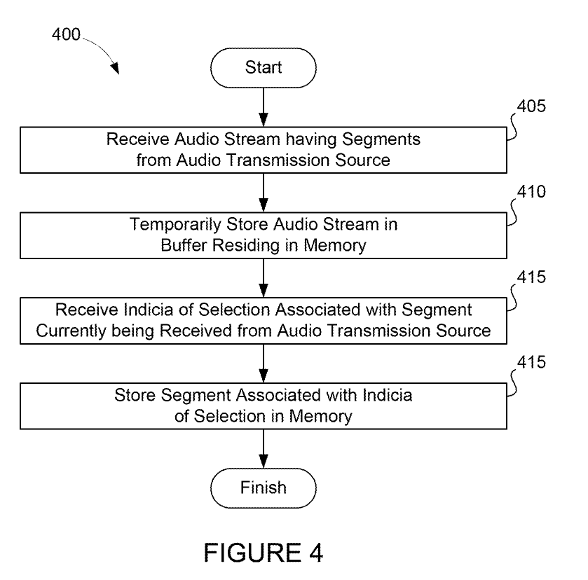

FIG. 4 is a flowchart illustrating an exemplary method 400 for preserving segments of an audio stream. The steps of the method 400 may be performed in varying orders. Steps may be added or subtracted from the method 400 and still fall within the scope of the present invention. The steps of FIG. 4 may also be embodied in instructions stored in a computer-readable storage medium, those instructions being executable by a processor.

In step 405, an audio stream is received by the audio playback device 105 from the audio transmission source 110. The audio stream may include a plurality of segments. Step 405 may be performed though execution of the communication module 305 by processor 220.

In step 410, the audio stream is temporarily stored in a buffer residing in the memory 425 of the audio playback device 105. The buffer may contain a contiguous portion of the audio stream from a preceding time period. For example, the buffer may contain that last fifteen minutes of the audio stream received by the audio playback device 105. Step 410 may be performed through execution of the buffering module 310 by the processor 220.

In step 415, indicia of a selection may be received via the user interface 210 of the audio playback device 105. The indicia of the selection may be associated with the segment being currently received from the audio transmission source 110. In one example, the user may press and hold a button on the user interface 210 to indicate a selection of the currently played segment of the audio stream. Step 415 may be performed through execution of the selection module 315 by processor 220.

In step 420, the segment associated with the indicia of the selection may be stored in the memory 425 of the audio playback device 105. The stored selection may be available to the user to play at a later time. The stored segment, in some instances, may not be transferred to other digital devices. Step 420 may be performed through execution of the data management module 320 by processor 220.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments.

It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for preserving the integrity of a segment of an audio stream, the method comprising:
receiving an audio stream at an audio playback device, the audio stream received from an audio transmission source, the audio stream comprising a plurality of segments;
temporarily storing the audio stream in a buffer that contains a contiguous portion of the audio stream from a preceding time period, the buffer residing in memory of the audio playback device;
receiving indicia of a selection through a user interface at the audio playback device, the indicia of the selection associated with the segment currently being received from the audio transmission source; and
storing the segment associated with the indicia of the selection in memory of the audio playback device.

2. The method of claim 1, wherein one or more of the plurality of segments includes a song.

3. The method of claim 1, further comprising analyzing the buffer to determine the beginning and the end of the segment associated with the indicia of the selection, wherein the storing of the segment associated with the indicia of the selection is based in part on a determination of the beginning and the end of the segment associated with the indicia of the selection.

4. The method of claim 1, further comprising:
receiving information about the segment associated with the indicia of the selection, the information including one or more of an artist name or a song title; and
associating the information with the stored segment.

5. The method of claim 1, further comprising replacing at least a portion of a the stored segment associated with the indicia of the selection with a subsequently acquired portion of the segment associated with the indicia of the selection.

6. The method of claim 5, wherein the subsequently acquired portion is a downloaded clean copy.

7. The method of claim 5, wherein the subsequently acquired portion of the segment is purchased.

8. The method of claim 1, further comprising degrading the stored segment.

9. The method of claim 1, further comprising applying a digital rights management wrapper to the stored segment.

10. The method of claim 1, wherein the stored segment is non-transferrable.

11. The method of claim 1, wherein the audio stream is degraded as a result of one or more of third-party voice-over, signal loss, signal compression, static noise, or signal interference.

12. A system for preserving the integrity of a segment of an audio stream, the system comprising:
a communications module stored in memory and executable by a processor to receive an audio stream from an audio transmission source, the audio stream comprising a plurality of segments;
a buffering module stored in memory and executable by a processor to temporarily store the audio stream in a buffer that contains a contiguous portion of the audio stream from a preceding time period, the buffer residing in memory of the audio playback device;
a selection module stored in memory and executable by a processor to receive via a user interface of the audio playback device indicia of a selection, the indicia of the selection associated with the segment being currently received from the audio transmission source; and
a data management module stored in memory and executable by a processor to store the segment associated with the indicia of the selection in memory of the audio playback device.

13. The system of claim 12, further comprising an analyzer module stored in memory and executable by a processor to analyze the buffer to determine the beginning and the end of the segment associated with the indicia of the selection, wherein storing the segment associated with the indicia of the selection in response to execution of the data management module is based in part on a determination of the beginning and the end of the segment associated with the indicia of the selection.

14. The system of claim 12, wherein the data management module is further executable by a processor to associate information with the stored segment, the information including one or more of an artist name or a song title.

15. The system of claim 12, further comprising a purchasing module stored in memory and executable by a processor to receive a request to purchase a clean copy of at least a portion of the segment associated with the indicia of the selection.

16. The system of claim 15, wherein the communications module is further executable by a processor to download the clean copy.

17. The system of claim 15, further comprising an editing module stored in memory and executable by a processor to replace at least a portion of the stored segment with the clean copy.

18. The system of claim 12, further comprising an editing module stored in memory and executable by a processor to degrade the stored segment.

19. The system of claim 12, further comprising an editing module stored in memoiy and executable by a processor to apply a digital rights management wrapper to the stored segment.

20. A computer readable storage medium having a program embodied thereon, the program executable by a processor to perform a method for preserving the integrity of a segment of an audio stream, the method comprising:
receiving an audio stream from an audio transmission source, the audio stream comprising a plurality of segments;
temporarily storing the audio stream in a buffer that contains a contiguous portion of the audio stream from a preceding time period;
receiving indicia of a selection, the indicia of the selection associated with the segment being currently received from the audio transmission source; and
storing the segment associated with the indicia of the selection in memory of the audio playback device.
